(19) United States
(12) Patent Application Publication
(10) Pub. No.: US 2024/0430391 A1
(43) Pub. Date: Dec. 26, 2024

(54) ELECTRONIC DEVICE AND METHOD FOR DRIVING THE SAME

(71) Applicant: SAMSUNG ELECTRONICS CO., LTD., Suwon-si (KR)

(72) Inventors: Hyungchul KIM, Suwon-si (KR); Seunghyun MOON, Suwon-si (KR); Kihong PARK, Suwon-si (KR); Youngjin CHO, Suwon-si (KR)

(73) Assignee: SAMSUNG ELECTRONICS CO., LTD., Suwon-si (KR)

(21) Appl. No.: 18/750,214

(22) Filed: Jun. 21, 2024

Related U.S. Application Data
(63) Continuation of application No. PCT/KR2024/008093, filed on Jun. 12, 2024.

(30) Foreign Application Priority Data
Jun. 21, 2023 (KR) 10-2023-0079923

(51) Int. Cl. H04N 9/31

(52) U.S. Cl. CPC H04N 9/3185; H04N 9/3188

(57) ABSTRACT

An electronic device includes a projection assembly configured to output an image to a projection surface; a memory configured to store at least one instruction; at least one sensor; and at least one processor configured to execute the at least one instruction, which causes the at least one processor to: detect a change in a projection environment; determine whether a focus correction is required for the image output to the projection surface, based on the change in the projection environment; after determining whether the focus correction is required, determine whether a keystone correction is required for the image, based on the change in the projection environment; and control the projection assembly to output a corrected image to the projection surface.

### CROSS-REFERENCE TO RELATED APPLICATIONS

This application is a continuation application, claiming priority under § 365 (c), of International application number PCT/KR2024/008093 filed on Jun. 12, 2024, which is based on and claims benefit of a Korean patent application number 10-2023-0079923, filed on Jun. 21, 2023, in the Korean Intellectual Property Office, the disclosures of which is incorporated by reference in its entirety.

### BACKGROUND

### 1. Field

One or more example embodiments of the disclosure relate to an electronic device outputting an image through a projection assembly (e.g., projector) and a method for driving the same.

### 2. Description of Related Art

As technology advances, electronic devices having diverse optical output functions are being developed, such as display devices, lighting devices, portable communication devices, and projectors. Among them, the projector is an electronic device that enlarges images and projects such images in form of light output from a light source to a wall or a screen through a projection lens.

As technology for projectors develops, technologies related to correcting the projected image, based on information about a projection area on which the projected image is projected, is drawing attention. For example, the projector may perform focus correction or keystone correction on the image output on a projection surface.

However, related art projectors perform focus correction and keystone correction at the same time or perform focus correction and keystone correction in an arbitrary order, thereby degrading image correction quality and/or requiring a long time for image correction.

### SUMMARY

One or more example embodiments of the disclosure may provide an electronic device and a method for driving the same, which may detect a change in a projection environment and determine whether focus correction is required and then determine whether keystone correction is required, thereby outputting a high-quality image.

According to an aspect of an example embodiment of the disclosure, provided is an electronic device, including: a projection assembly including a projection lens, the projection assembly configured to output an image to a projection surface; a memory configured to store at least one instruction; at least one sensor; and at least one processor configured to execute the at least one instruction, which causes the at least one processor to: detect a change in a projection environment; determine whether a focus correction is required for the image output to the projection surface, based on the change in the projection environment; after determining whether the focus correction is required, determine whether a keystone correction is required for the image, based on the change in the projection environment and control the projection assembly to output a corrected image to the projection surface . . . .

The at least one sensor may be configured to determine at least one of a projection distance or a projection angle, and the at least one instruction may cause the at least one processor to detect the change in the projection environment based on a change in at least one of the projection distance or the projection angle.

The at least one sensor may be configured to determine at least one of a projection distance and a projection angle, and the at least one instruction may cause the at least one processor to determine, based on the projection distance and the projection angle, whether the focus correction is required for the image output to the projection surface.

The at least one sensor may be configured to determine at least one of a projection distance and a projection angle, and the at least one instruction may cause the at least one processor to, after determining whether the focus correction is required, determine, based on the projection distance and the projection angle, whether the keystone correction is required for the image output to the projection surface.

The at least one sensor may be configured to determine at least one of a projection distance and a projection angle, and the at least one instruction may cause the at least one processor to perform the at least one of the focus correction or the keystone correction by determining movement information about the projection lens based on the projection distance and the projection angle.

The movement information about the projection lens may include at least one of a moving direction of the projection lens or a moving distance of the projection lens, and the projection assembly may be configured to control a movement of the projection lens based on the movement information.

The at least one sensor may be configured to sense image output size information and projection surface bend information, and the at least one instruction may cause the at least one processor to correct a range and a size of the image output to the projection surface based on the image output size information and the projection surface bend information.

The at least one instruction may cause the at least one processor to determine one of at least one projection area of the projection surface as an output area to which the image is to be output, based on the image output size information and the projection surface bend information.

The at least one instruction may cause the at least one processor to crop the image corresponding to a projection area having a largest size among the at least one projection area and output the cropped image to the output area.

The at least one instruction may cause the at least one processor to downsize the image output to the projection surface to a size of the output area and output the downsized image to the output area.

According to an aspect of an example embodiment of the disclosure, provided is a method of driving an electronic device, the method including: detecting a change in a projection environment; determining whether a focus correction is required based on the change in the projection environment; after determining whether the focus correction is required, determining whether a keystone correction is required; correcting the image; and outputting a corrected image to a projection surface.

The detecting the change in the projection environment may include: determining at least one of a projection distance or a projection angle; and detecting the change in the projection environment based on a change in at least one of the projection distance or the projection angle.

The detecting the change in the projection environment may include determining at least one of a projection distance and a projection angle; and the determining whether the focus correction is required includes determining, based on the projection distance and the projection angle, whether the focus correction is required for the image output to the projection surface.

The detecting the change in the projection environment may include determining at least one of a projection distance and a projection angle, and the determining whether the keystone correction is required may include: after determining whether the focus correction is required, determining, based on the projection distance and the projection angle, whether the keystone correction is required for the image output to the projection surface.

The detecting the change in the projection environment may include determining at least one of a projection distance and a projection angle, and the correcting the image includes performing at least one of the focus correction and the keystone correction by determining movement information about a projection lens based on the projection distance and the projection angle.

The movement information about the projection lens may include at least one of a moving direction of the projection lens or a moving distance of the projection lens, and the correcting the image includes controlling a movement of the projection lens based on the movement information.

The detecting the change in the projection environment may include determining image output size information and projection surface bend information, and the correcting the image includes correcting a range and a size of the image output to the projection surface based on the image output size information and the projection surface bend information.

The correcting the image may include determining one of at least one projection area of the projection surface as an output area to which the image is to be output, based on the image output size information and the projection surface bend information.

The correcting the image may include cropping the image corresponding to a projection area having a largest size among the at least one projection area, and the outputting the corrected image to the projection surface may include outputting the cropped image to the output area.

The correcting the image may include downsizing the image output to the projection surface to a size of the output area, and the outputting the corrected image to the projection surface may include outputting the downsized image to the output area.

According to various embodiments of the disclosure, the electronic device and method for driving the same of the disclosure may detect a projection environment change and first determine whether focus correction is required and then determine whether keystone correction is required, thereby maximizing an effect of focus correction and keystone correction.

Further, the electronic device and method for driving the same of the disclosure may determine an output area where an image is to be output based on detected data about the projection surface and perform correction on the image, thereby outputting an optimized image in various projection environments.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain example embodiments of the present disclosure will be more apparent from the following description taken in conjunction with the accompanying drawings, in which:

FIG. 1 is a view illustrating an exterior of an electronic device according to an example embodiment;

FIG. 2A is a block diagram illustrating a configuration of an electronic device according to an example embodiment;

FIG. 2B illustrates a detailed block configuration of an electronic device according to an example embodiment;

FIG. 3 illustrates an operation flow of an electronic device according to an example embodiment.

FIG. 4 illustrates a change in a projection environment of an electronic device according to an example embodiment;

FIG. 5 illustrates an operation of detecting a projection environment of an electronic device according to an example embodiment;

FIG. 6 illustrates an operation of focus correction of an electronic device according to an example embodiment;

FIG. 7 illustrates an operation of keystone correction of an electronic device according to an example embodiment;

FIG. 8 illustrates focus correction and keystone correction of an electronic device according to an example embodiment;

FIG. 9 illustrates a projection environment of an electronic device according to an example embodiment;

FIG. 10 illustrates a projection surface detection operation of an electronic device according to an example embodiment;

FIG. 11 illustrates an image output method of an electronic device according to an example embodiment;

FIG. 12 illustrates an image output method of an electronic device according to an example embodiment;

FIG. 13 illustrates an exterior of an electronic device according to an example embodiment of the disclosure;

FIG. 14 illustrates an exterior of an electronic device according to an example embodiment of the disclosure; and

FIGS. 15A, 15B, and 15C illustrate an exterior of an electronic device according to example embodiments.

### DETAILED DESCRIPTION

Example embodiments of the disclosure are now described with reference to the accompanying drawings in such a detailed manner as to be easily practiced by one of ordinary skill in the art. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

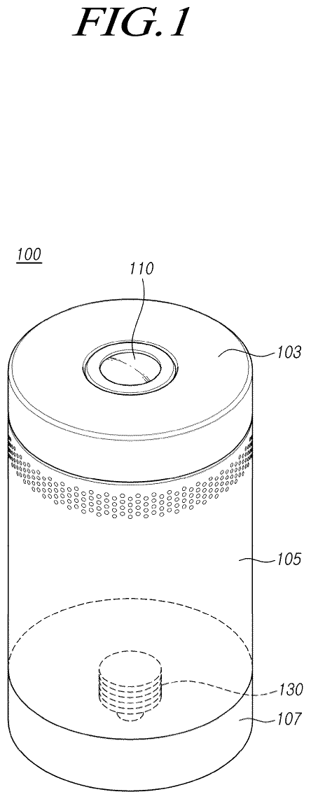

FIG. 1 illustrates an exterior of an electronic device 100 according to an example embodiment.

Referring to FIG. 1, an electronic device 100 may include a head 103, a main body 105, a projection lens 110, a connector 130, and a cover 107.

The electronic device 100 may include various types of devices. In particular, the electronic device 100 may be a projector device that magnifies and projects an image onto a wall or a screen. For example, the projector device may be a liquid crystal display (LCD) projector or a digital light processing (DLP) projector using a digital micromirror device (DMD).

Further, the electronic device 100 may be a home or industrial display device. Further, the electronic device 100 may be a lighting device used in everyday life. Further, the electronic device 100 may be a sound device including a sound module. Further, the electronic device 100 may be implemented as a portable communication device (e.g., a smart-phone), a computer device, a portable multimedia device, a wearable device, or a home appliance.

The electronic device 100, according to an embodiment, is not limited to the above-described devices, and for example, the electronic device 100 may be implemented as the electronic device 100 having two or more functions of the above-described devices. For example, the electronic device 100 may be utilized as at least one of a display device, a lighting device, and a sound device by turning off the projector function, among the two or more functions of the electronic device 100, and turning on the lighting function and/or the speaker function according to an operation of a processor. For example, the electronic device 100 may be utilized as an artificial intelligence (AI) speaker by including a microphone or a communication device.

The main body 105 may include a housing, which forms an exterior of the electronic device 100, and may support or protect components of the electronic device 100 disposed inside the main body 105. The shape of the main body 105 may be cylindrical as illustrated in FIG. 1. However, the shape of the main body 105 is not limited thereto, and according to one or more example embodiments of the disclosure, the main body 105 may be implemented in various geometric shapes such as a column having a polygonal cross section, a cone, and a sphere.

For example, the main body 105 may be implemented to be held or carried in one hand of the user. For example, the main body 105 may be implemented in a small size to be easily held. For example, the main body 105 may be implemented in a size to be mounted on a table and/or to be coupled to a lighting device.

For example, the exterior of the main body 105 may include a matte material not to leave a user's fingerprint or dust on the main body 105. For example, the exterior of the main body 105 may include a smooth glossy material.

For example, a friction area for facilitating the user to easily grip (e.g., hold or secure) the electronic device 100 may be provided in a partial area of the exterior of the main body 105. The friction area may have a friction of a certain value or greater, and a friction of the friction area may be greater than that of other area of the main body 105. Further, the main body 105 may include a grip portion or a support that may be gripped (e.g., held or secured) by the user in at least a partial area of the exterior of the main body 105.

The projection lens 110 may be provided on one side (e.g., surface) of the main body 105. The projection lens 110 may output light passing through the lens array toward an outside of the main body 105. For example, the projection lens 110 may be an optical lens coated with low dispersion to reduce chromatic aberration. For example, the projection lens 110 may be a convex lens or a condensing lens. The projection lens 110 may adjust the focus by adjusting positions of a plurality of sub lenses included in the projection lens 110.

The head 103 may be coupled to one side (e.g., surface) of the main body 105 to support and protect the projection lens 110. The head 103 may be coupled to the main body 105 to be swivelable in a predetermined angle range with respect to one side (e.g., surface) of the main body 105. For example, the head 103 may be automatically or manually swiveled, by the user or by the processor, to freely adjust the projection angle of the projection lens 110.

According to an embodiment of the disclosure, the head 103 may include a neck (e.g., extension or protrusion) (not shown) extending from the main body 105. For example, the head 103 may be tilted or inclined using the neck (not shown) extending from the main body 105 to adjust the projection angle of the projection lens 110.

The electronic device 100 may project light or an image to a desired position by adjusting the direction of the head 103 and adjusting an emission angle of the projection lens 110 while a position an angle of the main body 105 are fixed. Further, the head 103 may include a handle that the user may hold during and/or after rotating the head 103 in a desired direction.

A plurality of openings may be provided in an outer circumferential side (e.g., surface) of the main body 105. Audio output from an audio output unit (or an audio output) through the plurality of openings may be output to the outside of the main body 105 of the electronic device 100. For example, the audio output unit may include a speaker. The speaker may be used for general purposes such as multimedia playback, recording playback, and voice output.

According to an embodiment, the main body 105 may include a heat dissipation fan (not shown) therein. If the heat dissipation fan (not shown) inside the main body 105 is driven, the main body 105 may discharge air or heat inside the main body 105 through the plurality of openings. In this case, the main body 105 may discharge heat generated by driving the electronic device 100 to the outside so as to prevent the electronic device 100 from overheating.

The connector 130 may connect the electronic device 100 to an external device to transmit and/or receive an electrical signal to and/or from the external device, and/or may be used to receive power from the outside. The connector 130 may be physically connected to the external device. In this case, the connector 130 may include an input/output interface and may connect communication with the external device and/or receive power wiredly or wirelessly. For example, the connector 130 may include a high-definition multimedia interface (HDMI) connection terminal, a universal serial bus (USB) connection terminal, a secure digital (SD) card receiving slot, an audio connection terminal, and/or a power outlet. For example, the connector 130 may include a Bluetooth™, wireless-fidelity (Wi-Fi), or wireless charging connection module wirelessly connected to the external device.

Further, the connector 130 may have a socket structure connectable to an external lighting device. For example, the connector 130 may be connected to a socket receiving recess of the external lighting device to receive power. The size and specifications of the connector 130 of the socket structure may be implemented in various ways considering a receiving structure of a couplable external device. For example, according to the international standard E26, a diameter of a connecting portion of the connector 130 may be implemented as 26 mm. In this case, the electronic device 100 may be coupled to an external lighting device, such as a light stand, instead to a conventional light bulb.

According to an embodiment, although the electronic device 100 may be coupled to the socket on a wall (e.g., ceiling) to receive power, the electronic device 100 may adjust the emission angle of the projection lens 110 to emit light onto the screen at a desired position or rotate the screen as the head 103 swivels on one side (e.g., surface) of the main body 105 to be rotatable while the electronic device 100 is at a fixed position (e.g., coupled to a ceiling stand via socket).

The connector 130 may include a coupling sensor. For example, the coupling sensor may detect whether the connector 130 and the external device are coupled, that is, a coupled state, or whether the connector 130 and the external device are to be coupled, that is, a coupling target state, and transfer the detected information to the processor. In this case, the processor may control driving of the electronic device 100 based on the received detected value.

The cover 107 may protect the connector 130 such that the connector 130 is not always exposed to the outside. The cover 107 may be coupled to the main body 105 or may be separated from the main body 105. The cover 107 may have a shape continuous (e.g., extended) from the main body 105. The cover 107 may have a shape corresponding to the shape of the connector 130. The cover 107 may support the electronic device 100. For example, the electronic device 100 may be coupled to the cover 107 and mounted on an external cradle.

According to an embodiment, the electronic device 100 may include a battery inside the cover 107. For example, the battery may include at least one of a non-rechargeable primary cell, a rechargeable secondary cell, and a fuel cell.

Although not shown in the drawings, the electronic device 100 may include a camera module. The camera module may capture a still image and/or a video. For example, the camera module may include one or more lenses, an image sensor, an image signal processor, and/or a flash.

Although not shown in the drawings, the electronic device 100 may include a protective case (not shown) to protect and easily carry (e.g., hold) the electronic device 100. Alternatively, the electronic device 100 may include a stand (not shown) that supports or fixes the main body 105, and a bracket (not shown) that may be coupled to a wall side (e.g., surface) or a partition.

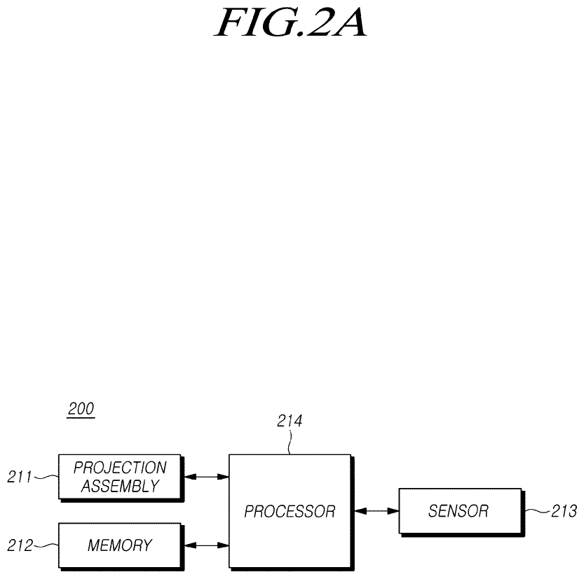

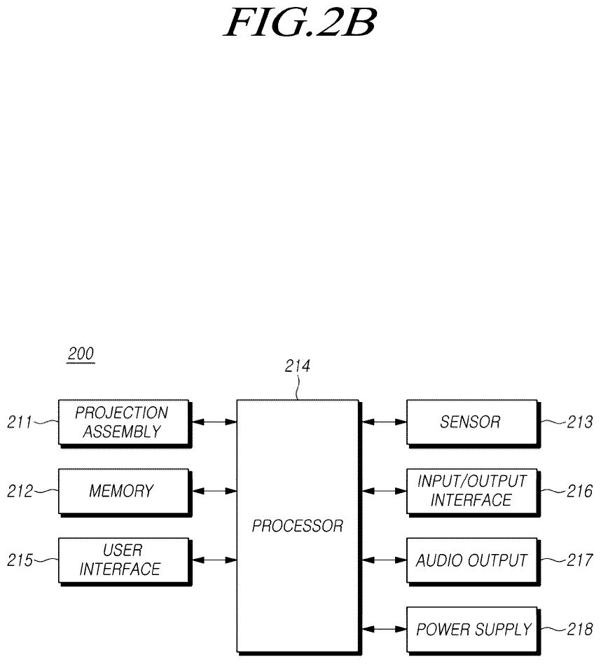

The electronic device 100 may be connected to various external devices using a socket structure to provide various functions. For example, the electronic device 100 may be connected to an external camera device using a socket structure. The electronic device 100 may provide an image stored in the connected camera device or an image currently being captured using a projection assembly 211 (see FIG. 2A). As another example, the electronic device 100 may be connected to the battery module using the socket structure to receive power. The electronic device 100 may be connected to an external device using a socket structure, but this is merely an example embodiment, and the electronic device 100 may be connected to an external device using another interface (e.g., USB).

FIG. 2A is a block diagram illustrating a configuration of an electronic device 200 according to an example embodiment.

Referring to FIG. 2A, an electronic device 200 may include a projection assembly 211, memory 212, a sensor 213, and a processor 214.

The projection assembly 211 may perform a function of outputting an image to a projection surface. The projection surface may be a part of a physical space in which an image is output or may be a separate screen. A detailed description related to the projection assembly 211 is described with reference to FIG. 2B.

The projection assembly 211 may include a projection lens (e.g., 110 of FIG. 1) for outputting an image on the projection surface and a movement controller (not shown) for shifting (e.g., adjusting or moving) the projection lens. The projection lens may be shifted (e.g., adjusted or moved) under the control of the processor 214. For example, the projection lens may change at least one of a projection distance and a projection angle of the projection assembly 211 based on the control of the movement controller (not shown). At least one of a position and a size of the image output on the projection surface may be changed based on a change in the projection distance and the projection angle.

The memory 212 may store data corresponding to the image output on the projection surface. For example, the memory 212 may store at least one image to be output through the projection assembly 211. Here, the image may include a video as well as a still image. Further, the image may refer to a content including a still image and a video. A detailed description related to the memory 212 is described with reference to FIG. 2B.

The sensor 213 may include at least one sensor for detecting a projection environment. The sensor 213 may include at least one of a distance sensor for detecting a distance, a three-dimensional space recognition sensor for analyzing a space, an image sensor, and an acceleration sensor. The distance sensor may refer to a sensor that obtains detection data for measuring a distance. The three-dimensional space recognition sensor may refer to a sensor that obtains the detection data for recognizing a three-dimensional space. For example, the sensor 213 may include at least one of an infrared sensor, an ultrasonic sensor, a laser sensor, a light detection and ranging (LiDAR) sensor, and an image sensor. The image sensor may include at least one of a camera or a depth camera. The tilt sensor may include at least one of an acceleration sensor and a gyro sensor.

The processor 214 may perform an overall control operation of the electronic device 200. For example, the processor 214 may control the overall operation of the electronic device 200.

The processor 214 may detect a change in the projection environment through the sensor 213. The processor 214 may determine whether the image needs to be corrected based on a change in the projection environment. The processor 214 may determine whether focus correction for an image is required. For example, the processor 214 may perform focus correction based on the projection distance and the projection angle. The processor 214 may determine whether keystone correction is required for the image. For example, the processor 214 may perform keystone correction based on the projection distance and the projection angle. The processor 214 may control the projection assembly 211 to output the corrected image on the projection surface. For example, the processor 214 may determine movement information about the projection lens based on the projection distance and the projection angle and perform correction of the image based on the movement information.

The processor 214 may obtain the detection data for measuring the distance between the projection surface and the electronic device 200 through the sensor 213. The processor 214 may obtain distance information between the projection surface and the electronic device 200 based on the obtained the detection data.

The processor 214 may obtain output size information about the image based on the distance information to the projection surface. Here, the output size information associated with the image may mean an actual size of the image output on the projection surface. Accordingly, even if an image having the same resolution is output, output size information about the image may be different based on distance information.

The processor 214 may obtain projection surface information based on the detection data obtained through the sensor 213. The projection surface may mean a space on which an image is to be output, and the projection surface may mean a wall, a screen, or the like. The projection surface information may include at least one of a size of the projection surface, a position of the projection surface, a material of the projection surface, a shape of the projection surface, whether the projection surface has a bend, a position of the bend included in the projection surface, a length of the bend included in the projection surface, or a number of bends included in the projection surface.

In an embodiment, the detection data used to obtain distance information and projection surface information may be obtained through the same sensor. For example, each of the distance information and the projection surface information may be obtained through a first sensor. For example, the first sensor may be a LiDAR sensor.

In an embodiment, the detection data used to obtain distance information and projection surface information may be obtained through different sensors. For example, distance information may be obtained through a first sensor, and projection surface information may be obtained through a second sensor. For example, the first sensor may be an infrared sensor and the second sensor may be a LiDAR sensor.

The processor 214 may identify a bend included in the projection surface based on the detection data. Bend may refer to, for example, a boundary line, a boundary area, or an edge for distinguishing between a wall (e.g., a first projection surface) and another wall (e.g., a second projection surface). Here, the processor 214 may identify at least one of the position of the bend, the length of the bend, or the total number of bends.

FIG. 2B illustrates a detailed block configuration of the electronic device 200.

Referring to FIG. 2B, the electronic device 200 may include a projection assembly 211, a memory 212, a sensor 213, a processor 214, a user interface 215, an input/output interface 216, an audio output 217, and a power supply 218. Here, some descriptions of the projection assembly 211, the memory 212, the sensor 213, and the processor 214 have been described with reference to FIG. 2A, and thus duplicate descriptions thereof are omitted. The components illustrated in FIG. 2B is merely an embodiment, and some components may be omitted, and a new component may be added.

The projection assembly 211 may be a component for projecting an image to the outside. The projection assembly 211 according to an embodiment of the disclosure may be implemented in various projection methods (e.g., a cathode-ray tube (CRT) method, a LCD method, a DLP method, a laser method).

For example, the CRT method may be basically the same as a projection method by a CRT monitor. The CRT method may magnify an image with a lens in front of a CRT and display the image on the screen. Depending on a number of cathode-ray tubes, the CRT method may be divided into a single-tube type and a three-tube type, and in a case of the three-tube type, cathode-ray tubes of red, green, and blue (RGB) may be implemented separately.

For example, the LCD method may be a method of displaying an image by transmitting light from a light source to liquid crystal. The LCD method may be divided into a single plate type and a three plate type, and in a case of the three plate type, light from the light source may be separated into red, green, and blue by a dichroic mirror (a mirror that reflects only light of a specific color and passes the rest), and then light may gather in one place again after passing through the liquid crystal.

For example, the DLP method may be a method of displaying an image using a DMD chip. A DLP projection unit may include a light source, a color wheel, a DMD chip, a projection lens, and the like. Light output from the light source may be colored while passing through a rotating color wheel. The light transmitted through the color wheel may be input to the DMD chip. The DMD chip may include numerous micromirrors. The DMD chip may reflect light input to the DMD chip using the micromirrors. For example, the projection lens may serve to magnify light reflected from the DMD chip to the size of the image.

For example, the laser method may include a diode pumped solid state (DPSS) laser and a galvanometer. As a laser outputting various colors, three (3) DPSS lasers may be installed for each RGB color, and then laser beams, whose optical axes overlap, may be used using a special mirror. The galvanometer may include a mirror and a high-output motor and move the mirror at high speed. For example, the galvanometer may rotate the mirror at up to 40 KHz/sec. The galvanometer may be mounted according to a scan direction, and in general, the projector may perform planar scanning, and galvanometers may be disposed separately in x-axes and y-axes.

The projection assembly 211 may include various types of light sources. For example, the projection assembly 211 may include at least one light source among a lamp, an LED, and a laser.

The projection assembly 211 may output an image, for example, in a 4:3 aspect ratio, a 5:4 aspect ratio, and a 16:9 wide aspect ratio according to the use of the electronic device 200 or user settings and may output an image in various resolutions such as WVGA (854*480), SVGA (800*600), XGA (1024*768), WXGA (1280*720), WXGA (1280*800), SXGA (1280*1024), UXGA (1600*1200), and full HD (1920*1080) according to the aspect ratio.

The projection assembly 211 may perform various functions for adjusting the output image under the control of the processor 214. For example, the projection assembly 211 may perform functions such as zoom, keystone, quick corner (e.g., four (4) corner) keystone, and lens shift.

In an embodiment, the projection assembly 211 may magnify or reduce the image according to the distance (e.g., projection distance) to the screen. In other words, the zoom function may be performed based on the distance from the screen. In this case, the zoom function may include a hardware-wise method of adjusting the screen size by moving (e.g., shifting) the lens and a software-wise method of adjusting the size of the screen by cropping the image.

When the zoom function is performed, it may be required to adjust the focus (e.g., focus correction) of the image. For example, the method of adjusting the focus may include a manual focusing method, an electric method, and the like. The manual focusing method refers to a method of manually performing focusing, and the electric method refers to a method of automatically performing focusing using a motor having a built-in projector when the zoom function is performed. When performing the zoom function, the projection assembly 211 may provide a digital zoom function through software and may provide an optical zoom function of performing the zoom function by moving the lens through a driving unit (e.g., driver).

Further, the projection assembly 211 may perform a keystone function (e.g., keystone correction). If a height of the electronic device 100 (e.g., the projection lens) does not match a front projection, the screen may be distorted up or down. The keystone function refers to a function of correcting the distorted screen. For example, if distortion occurs in a left-right direction of the screen, the distortion may be corrected using horizontal keystone, and if distortion occurs in an up-down direction, the distortion may be corrected using vertical keystone. The quick corner (e.g., four (4) corner) keystone function may be a function of correcting the screen if a central area of the screen is normal but corner areas are not balanced. The lens shift function may be a function of moving a screen if the screen is out of a normal screen area.

The projection assembly 211 may perform at least one of zoom correction, keystone correction, and focus correction by automatically analyzing the surrounding environment and the projection environment without a user input. In an embodiment, the projection assembly 211 may automatically perform at least one of zoom correction, keystone correction, or focus correction based on the distance between the electronic device 200 and the screen detected through a sensor (e.g., a depth camera, a distance sensor, an infrared sensor, or an illuminance sensor), information about the space in which the electronic device 200 is currently positioned, information about an ambient light amount, or the like.

The projection assembly 211 may provide a lighting function using a light source. In particular, the projection assembly 211 may provide a lighting function by outputting light using an LED. For example, the projection assembly 211 may include at least one LED. For example, the projection assembly 211 may output light using a surface light emitting LED. Here, the surface light emitting LED may refer to LEDs having a structure in which an optical sheet is disposed above the LEDs to evenly disperse and output light. In an embodiment, light output from the LEDs may be evenly dispersed through the optical sheet and be incident on the display panel.

The projection assembly 211 may provide a dimming function for adjusting the intensity of the light source. For example, if a user input for adjusting the intensity of the light source is received through the user interface 215 (e.g., a touch display button or a dial), the projection assembly 211 may control the LED to output the light of the intensity corresponding to the received user input. As another example, the projection assembly 211 may provide a dimming function based on content analyzed by the processor 214 without a user input. In an embodiment, the projection assembly 211 may control the LED to output light of the intensity based on information (e.g., content type, or content brightness) about the currently provided content.

The projection assembly 211 may control color temperature under the control of the processor 214. For example, the processor 214 may control the color temperature based on content of an image. In an embodiment, if the content is output as an image, the processor 214 may obtain color information about each frame of the content determined to be output. The processor 214 may control the color temperature based on the obtained color information for each frame. Here, the processor 214 may obtain at least one main color of the frame based on the color information for each frame. The processor 214 may adjust the color temperature based on the obtained at least one main color. For example, the color temperature adjustable by the processor 214 may be classified into a warm type or a cold type. Here, it is assumed that the frame to be output (hereinafter, referred to as an output frame) includes a scene in which a fire breaks out. The processor 214 may identify (or obtain) that the main color is red based on the color information included in the current output frame. The processor 214 may identify the color temperature corresponding to the identified main color-red. Here, the color temperature corresponding to red may be the warm type. The processor 214 may use an artificial intelligence model to obtain the color information or the main color of the frame. For example, the artificial intelligence model may be stored in the electronic device 200 (e.g., the memory 212). As another example, the artificial intelligence model may be stored in an external server capable of communicating with the electronic device 200.

The electronic device 200 may control the lighting function in conjunction with an external device. In an embodiment, the electronic device 200 may receive lighting information from the external device. Here, the lighting information may include at least one of brightness information or color temperature information set by the external device. Here, the external device may refer to a device connected to the same network as the electronic device 200 (e.g., an IoT device included in the same home/company network) or a device (e.g., a remote control server) that is not the same network as the electronic device 200 but is capable of communicating with the electronic device. For example, it is assumed that an external lighting device (e.g., IoT device) included in the same network as the electronic device 200 outputs red light at a brightness of 50. The external lighting device (e.g., IoT device) may directly or indirectly transmit lighting information (e.g., information indicating that red light is output at a brightness of 50) to the electronic device 200. Here, the electronic device 200 may control the output of the light based on the lighting information received from the external lighting device. For example, if the lighting information received from the external lighting device includes information indicating outputting of the red light at a brightness of 50, the electronic device 200 may output the red light at a brightness of 50.

The electronic device 200 may control the lighting function based on biometric information. In an embodiment, the processor 214 may obtain biometric information. Here, the biometric information may include at least one of a body temperature, heart rate, blood pressure, respiration, and electrocardiogram. Here, the biometric information may include various information other than the above-described information. For example, the electronic device may include a sensor for measuring biometric information. The processor 214 may obtain biometric information through the sensor and control the output of the light source based on the obtained biometric information. As another example, the processor 214 may receive biometric information from an external device through the input/output interface 216. Here, the external device may refer to a portable communication device (e.g., a smartphone or a wearable device). The processor 214 may obtain biometric information from the external device and control the output of the light source based on the obtained biometric information. According to an embodiment, the electronic device may identify whether the user is sleeping, and if it is identified that the user is sleeping (or preparing for sleep), the processor 214 may control the output of the light source based on the biometric information about the user.

The memory 212 may store at least one instruction regarding the electronic device 200. The memory 212 may store an operating system (OS) for driving the electronic device 200. Further, the memory 212 may store various software programs or applications for operating the electronic device 200 according to one or more example embodiments. The memory 212 may include a semiconductor memory such as a flash memory, a magnetic storage medium such as a hard disk, or the like.

Specifically, the memory 212 may store various software modules for operating the electronic device 200 according to one or more example embodiments. For example, the processor 214 may control the operation of the electronic device 200 by executing various software modules stored in the memory 212. In other words, the memory 212 may be accessed by the processor 214, and various operations such as reading, writing, modifying, deleting, and/or updating of data by the processor 214 may be performed.

Herein, the term “memory” (or “memory 212”) may be used as a meaning including the memory 212, a read only memory (ROM) (not illustrated) and a random access memory (RAM) (not illustrated) in the processor 214, and/or a memory card (not illustrated) (e.g., a micro secure digital (SD) card or a memory stick) mounted on the electronic device 200.

The user interface 215 may include various types of input devices. For example, the user interface 215 may include a physical button. In this case, the physical button may include a function key, a direction key (e.g., a four-direction key), or a dial button. For example, the physical button may be implemented with multiple keys. As another example, the physical button may be implemented as one key. Here, if the physical button is implemented as one key, the electronic device 200 may receive a user input in which one key is pressed for at least a predetermined time. If the user input, in which one key is pressed for at least a predetermined time, is received, the processor 214 may perform a function corresponding to the user input. For example, the processor 214 may provide a lighting function based on the user input.

Further, the user interface 215 may receive the user input using a contactless method. If the user input is received through a contact method, a physical force may be transferred to the electronic device. Therefore, a method for controlling the electronic device, regardless of a physical force, may be required. In an embodiment, the user interface 215 may receive a user gesture and perform an operation corresponding to the received user gesture. Here, the user interface 215 may receive the user's gesture through a sensor (e.g., an image sensor or an infrared sensor).

Further, the user interface 215 may receive a user input using a touch method. For example, the user interface 215 may receive the user input through a touch sensor. According to an embodiment, the touch method may be implemented as a contactless method. For example, the touch sensor may determine whether the user's body approaches within a threshold (e.g., predetermined) distance.

Here, the touch sensor may identify the user input even if the user does not contact the touch sensor. According to another embodiment, the touch sensor may identify a user input in which the user contacts the touch sensor.

The electronic device 200 may receive the user input in various ways other than by the user interface described above. In an embodiment, the electronic device 200 may receive a user input through an external remote control device. Here, the external remote control device may be a remote control device (e.g., a control device dedicated to the electronic device) corresponding to the electronic device 200 or a portable communication device (e.g., a smartphone or a wearable device). Here, the portable communication device may have an application for controlling the electronic device. The portable communication device may obtain a user input through the application and transmit the obtained user input to the electronic device 200. The electronic device 200 may receive a user input from a portable communication device and perform an operation corresponding to a control command of the user.

The electronic device 200 may receive a user input using voice recognition. For example, the electronic device 200 may receive a voice input through a microphone included in the electronic device. As another example, the electronic device 200 may receive a voice input from a microphone or an external device. In an embodiment, the external device may obtain a voice input through a microphone of the external device, and transmit the obtained voice input to the electronic device 200. The voice input transmitted from the external device may be audio data or digital data (e.g., audio data converted into a frequency domain) converted into from the audio data. Here, the electronic device 200 may perform an operation corresponding to the received voice input. In an embodiment, the electronic device 200 may receive audio data corresponding to the voice input through the microphone. The electronic device 200 may convert the received audio data into digital data. The electronic device 200 may convert the converted digital data into text data using a speech to text (STT) function. For example, the speech to text (STT) function may be directly performed by the electronic device 200. As another example, a STT function may be performed by an external server. The electronic device 200 may transmit digital data to the external server. The external server may convert the digital data into text data and obtain control command data based on the converted text data. The external server may transmit the control command data to the electronic device 200. The electronic device 200 may perform an operation corresponding to the voice input based on the obtained control command data.

The electronic device 200 may provide a voice recognition function using an assistance (or an artificial intelligence assistant, e.g., Bixby™), but this is merely an example, and the electronic device 200 may provide a voice recognition function through a plurality of assistances. Here, the electronic device 200 may provide a voice recognition function by selecting one of a plurality of assistances based on a trigger word corresponding to the assistance or a specific key present in the remote controller.

The electronic device 200 may receive a user input using a screen interaction. The screen interaction may refer to a function of identifying whether a predetermined event occurs through an image projected on the screen (or the projection surface) by the electronic device and obtaining a user input based on the predetermined event. Here, the predetermined event may refer to an event in which a predetermined object is identified at a specific position (e.g., a position where a UI for receiving the user input is projected). Here, the predetermined object may include at least one of the user's body part (e.g., a finger), an indicator rod, or a laser point. When a predetermined object is identified at the position corresponding to the projected UI, the electronic device 200 may identify that the user input for selecting the projected UI is received. For example, the electronic device 200 may project a guide image to display a UI on the screen. The electronic device 200 may identify whether the user selects the projected UI. In an embodiment, when the predetermined event is identified at the position of the projected UI, the electronic device 200 may identify that the user has selected the projected UI. Here, the projected UI may include at least one item. Here, the electronic device 200 may perform spatial analysis to identify whether the predetermined event is positioned on the projected UI. Here, the electronic device 200 may perform spatial analysis through a sensor (e.g., an image sensor, an infrared sensor, a depth camera, or a distance sensor). The electronic device 200 may identify whether a predetermined event occurs at a specific position (e.g., a position where the UI is projected) by performing spatial analysis. Further, if it is identified that a predetermined event occurs at a specific position (e.g., the position where the UI is projected), the electronic device 200 may identify that a user input for selecting a UI corresponding to the specific position is received.

The input/output interface 216 may be a component for input/outputting at least one of an audio signal and an image signal. The input/output interface 216 may receive at least one of an audio signal and an image signal from an external device, and may output a control command to the external device.

For example, the input/output interface 216 may be implemented as at least one wired input/output interface among a high definition multimedia interface (HDMI), a mobile high-definition link (MHL), a universal serial bus (USB), a USB C-type, a display port (DP), the Thunderbolt, a video graphics array (VGA) port, an RGB port, a D-SUB, and a digital visual interface (DVI). According to an embodiment, the wired input/output interface may be implemented as an interface that inputs and outputs only audio signals and an interface that inputs and outputs only image signals or may be implemented as one interface that inputs and outputs both audio signals and image signals.

Further, the electronic device 200 may receive data through the wired input/output interface, but this is merely an example, and the electronic device 200 may receive power through the wired input/output interface. For example, the electronic device 200 may be supplied with power from an external battery through a USB C-type or may be supplied with power from an outlet through a power adapter. As another example, the electronic device may receive power from an external device (e.g., a notebook computer or a monitor) through a DP.

The input/output interface 216 may be implemented as a wireless input/output interface that performs communication by at least one communication method among communication methods of Wi-Fi, Wi-Fi direct, Bluetooth™, Zigbee™, 3rd generation (3G), 3rd generation partnership project (3GPP), and long-term evolution (LTE). According to an embodiment, the wireless input/output interface may be implemented as an interface that inputs and outputs only audio signals and an interface that inputs and outputs only image signals or may be implemented as one interface that inputs and outputs both audio signals and image signals.

The audio signal may be input through the wired input/output interface, and the image signal may be input through the wireless input/output interface. Alternatively, the audio signal may be input through the wireless input/output interface, and the image signal may be input through the wired input/output interface.

The audio output 217 may be a component for outputting the audio signal. In particular, the audio output 217 may include an audio output mixer, an audio signal processor, and a sound output module. The audio output mixer may synthesize a plurality of audio signals to be output into at least one audio signal. For example, the audio output mixer may synthesize an analog audio signal and another analog audio signal (e.g., an analog audio signal received from the outside) into at least one analog audio signal. The sound output module may include a speaker or an output terminal. According to an embodiment, the sound output module may include a plurality of speakers. In this case, the sound output module may be disposed inside the main body (e.g., main body 105 of the electronic device 100 in FIG. 1), and sound that is radiated while covering at least a portion of the diaphragm of the sound output module may be transferred to the outside of the main body through a waveguide.

The sound output module may include a plurality of sound output units, and the plurality of sound output units may be symmetrically disposed on the exterior of the main body to radiate sound in all directions (e.g., all 360 degrees).

The power supply 218 may receive power from the outside and supply the power to various components of the electronic device 200. The power supply 218 according to an embodiment may receive power through various methods. For example, the power supply 218 may receive power using the connector 130 as illustrated in FIG. 1. Further, the power supply 218 may receive power using a direct current (DC) power cord of 220V. However, the power supply 218 of the disclosure is not limited thereto, and the electronic device 200 may be supplied with power using a USB cable or may be supplied with power using a wireless charging method.

Further, the power supply 218 may receive power using an internal battery or an external battery. The power supply 218 according to an embodiment of the disclosure may receive power through an internal battery. For example, the power supply 218 may charge the internal battery using at least one of a DC power cord of 220 V, a USB cable, and a USB C-type cable and may receive the power through the charged internal battery. Further, the power supply 218, according to an embodiment, may receive power through an external battery. For example, if the electronic device and the external battery are connected through various wired communication methods such as a USB cable, a USB C-type cable, and a socket recess, the power supply 218 may receive power through the external battery. In other words, the power supply 218 may receive power directly from the external battery, and/or may charge the internal battery through the external battery and receive power from the charged internal battery.

The power supply 218 may receive power using at least one of the plurality of power supply methods described above.

With respect to power consumption, the electronic device 200 may have power consumption of a predetermined value (e.g., 43 W) or less due to a socket shape or other standards. Here, the electronic device 200 may vary the power consumption to reduce the power consumption when using the battery. In other words, the electronic device 200 may vary power consumption based on a power supply method, a power usage amount, and the like.

The electronic device 200, according to an embodiment, may provide various smart functions.

In an embodiment, the electronic device 200 may be connected to a portable terminal device for controlling the electronic device 200, and a screen output from the electronic device 200 may be controlled through a user input received via the portable terminal device. For example, the portable terminal device may be implemented as a smartphone including a touch display. For example, the electronic device 200 may receive and output from the portable terminal device screen data provided by (or on) the portable terminal device, and the screen output from the electronic device 200 may be controlled based on the user input received through the portable terminal device.

The electronic device 200 may be connected to a portable terminal device through various communication methods such as Miracast™, Airplay™, Wireless Dalvik executable (DEX), remote PC, and the like to share content or music provided by the portable terminal device.

Further, the portable terminal device and the electronic device 200 may be connected in various connection methods. According to an embodiment, the portable terminal device may perform search to establish wireless connection with the electronic device 200, or the electronic device 200 may perform search to establish wireless connection with the portable terminal device. Further, the electronic device 200 may output content provided by the portable terminal device.

In an embodiment, when a predetermined gesture is detected (e.g., a motion tap view) through the display of the portable terminal device after placing the portable terminal device near the electronic device while the specific content or music is being output from the portable terminal device, the electronic device 200 may output the content or music being output from the portable terminal device.

In an embodiment, if the portable terminal device approaches (e.g., gets close) the electronic device 200 within a predetermined distance (e.g., a contactless tap view) while a specific content or music is being output from the portable terminal device, or if the portable terminal device contacts (e.g., touches or taps) the electronic device 200 twice in short intervals (e.g., a contact tap view), the electronic device 200 may output (e.g., transmit) the content or music being output from the portable terminal device.

In the above-described embodiment(s), it has been described that the same screen as the screen provided by the portable terminal device is provided by the electronic device 200, but the disclosure is not limited thereto. In other words, if a connection between the portable terminal device and the electronic device 200 is established, the portable terminal device may output a first screen provided by the portable terminal device, and the electronic device 200 may output a second screen provided by the portable terminal device different from the first screen. For example, the first screen may be a screen provided by a first application installed in the portable terminal device, and the second screen may be a screen provided by a second application installed in the portable terminal device. For example, the first screen and the second screen may be different screens provided by one application installed in the portable terminal device. Further, e.g., the first screen may be a screen including a UI of a remote control format for controlling the second screen.

The electronic device 200 may output a standby screen. For example, if the electronic device 200 is not connected to an external device or there is no input received from the external device for a predetermined time, the electronic device 200 may output the standby screen. The condition for the electronic device 200 to output the standby screen is not limited to the above-described example, and the standby screen may be output according to various conditions.

The electronic device 200 may output the standby screen in a form of a blue screen, but the disclosure is not limited thereto. For example, the electronic device 200 may obtain an unstructured object by extracting only the shape of a specific object from the data received from the external device and output a standby screen including the obtained unstructured object.

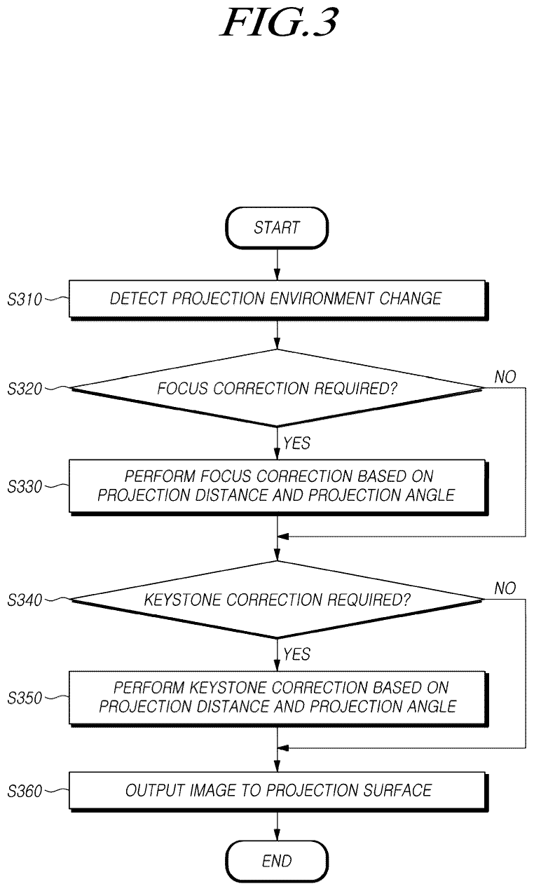

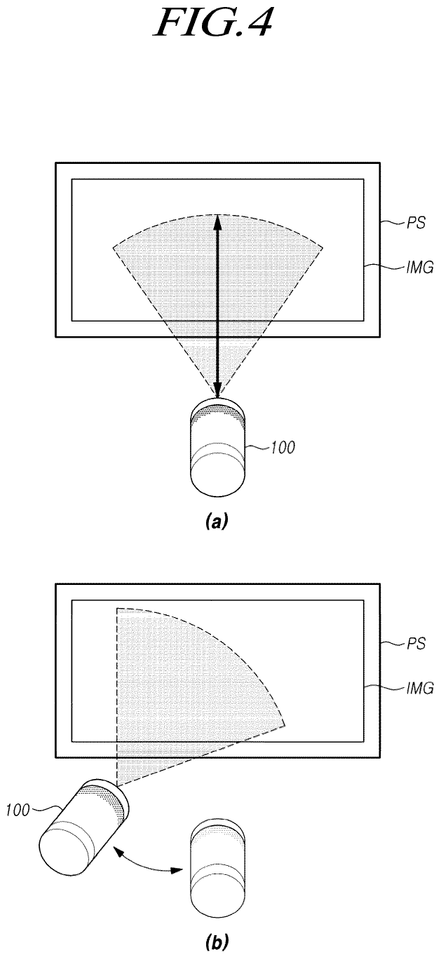

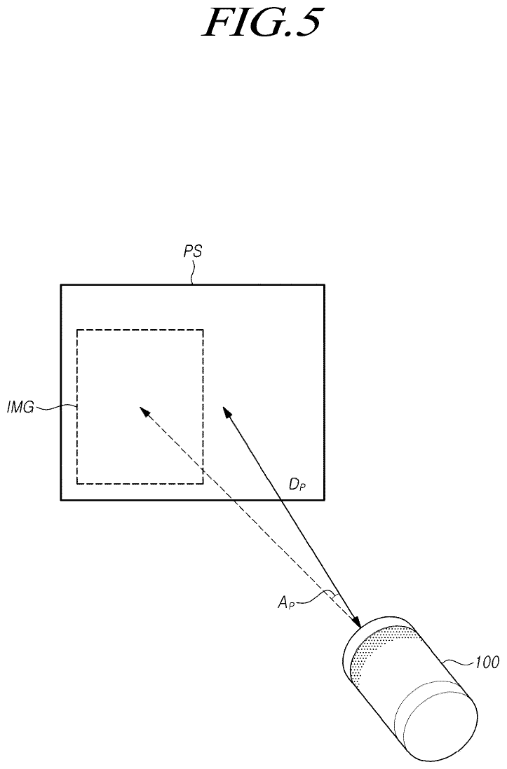

FIG. 3 illustrates an operation flow of an electronic device according to an example embodiment. FIG. 4 illustrates a projection environment change of an electronic device according to an example embodiment. FIG. 5 illustrates an operation of detecting a projection environment of an electronic device according to an example embodiment.

Referring to FIG. 3, the electronic device 100 may detect a change in a projection environment. The electronic device 100 may determine whether focus correction is required based on change in the projection environment. For example, if focus correction is required, the electronic device 100 may perform focus correction based on the projection distance and the projection angle. After determining whether focus correction is required, the electronic device 100 may determine whether keystone correction is required. For example, if the keystone correction is required, the electronic device 100 may perform the keystone correction based on the projection distance and the projection angle. The electronic device 100 may output an image on the projection surface (e.g., screen or wall). In other words, the electronic device 100 may first determine whether focus correction is required, and then determine whether keystone correction is required, thereby maximizing the effect of focus correction and keystone correction.

According to an embodiment, in operation 310, the electronic device 100 may detect change in a projection environment. For example, the sensor of the electronic device 100 may include a distance sensor for measuring (e.g., determining) the projection distance and a tilt sensor for measuring (e.g., determining) the projection angle. The distance sensor may refer to a sensor that obtains data related to measured distance. For example, the distance sensor may include at least one of an ultrasonic sensor, a laser sensor, a LiDAR sensor, and a 3D time of flight (ToF) sensor.

As shown in (a) of FIG. 4, the electronic device 100 may detect a change in the projection distance between the electronic device 100 and a projection surface PS on which the image IMG is output using the distance sensor. The tilt sensor may include at least one of an acceleration sensor and a gyro sensor. As illustrated in (b) of FIG. 4, the electronic device 100 may detect a change in the projection angle of the electronic device 100 outputting the image IMG on the projection surface PS using the tilt sensor. For example, the electronic device 100 may measure the projection distance and the projection angle using the distance sensor and the acceleration sensor, respectively. For example, the electronic device 100 may determine the projection distance and the projection angle using the distance sensor and the gyro sensor, respectively. For example, the electronic device 100 may measure the projection distance and the projection angle using the distance sensor, the acceleration sensor, and the gyro sensor. Further, the electronic device 100 may determine various projection environments in combination of the distance sensor and the tilt sensor with at least one of an infrared sensor, an ultrasonic sensor, a laser sensor, and a LiDAR sensor. As such, the electronic device 100 may detect a change in the projection environment based on a change in at least one of the projection distance and the projection angle.

In an embodiment, the sensor of the electronic device 100 may include an image sensor that detects intensity and color information about light in a projection environment. For example, the image sensor may include at least one of a camera or a depth camera. The electronic device 100 may detect a change in the projection environment based on a change in light intensity and color information about the projection environment. For example, the electronic device 100 may detect a change in the projection distance and a change in the intensity and color information about light in the projection environment in combination of the distance sensor and the image sensor. For example, the electronic device 100 may detect a change in the projection angle and a change in the intensity and color information about light in the projection environment in combination of the tilt sensor and the image sensor. Further, the electronic device 100 may detect various projection environments in combination of an image sensor with at least one of an infrared sensor, an ultrasonic sensor, a laser sensor, and a LiDAR sensor.

In an embodiment, the electronic device 100 may determine a change in a projection environment based on the detection data detected by the sensor. In an embodiment, the electronic device 100 may identify a change in a projection environment based on at least one of a projection distance change, a projection angle change, and a change in light intensity and color information about the projection environment detected based on at least one of the distance sensor, the tilt sensor, and the image sensor. For example, if a change in the projection environment exceeds a pre-stored reference change threshold (or limit), the electronic device 100 may classify the projection environment change as a first environment change. For example, the first environmental change may include at least one of a fall of the electronic device 100, a drop of the electronic device 100, or a change in the physical position of the electronic device 100. For example, if a change in the projection environment is less than or equal to the pre-stored reference change threshold (or limit), the electronic device 100 may classify the projection environment change as a second environment change. For example, the second environmental change may include a slight change in the position of the electronic device 100 due to vibration of the electronic device 100 or an external physical force.

The reference change amount may include a projection distance threshold and a projection angle threshold. For example, if a change in the projection distance exceeds the projection distance threshold, the electronic device 100 may classify the projection environment change as the first environment change, and if a change in the projection distance is less than or equal to the projection distance threshold, the electronic device 100 may classify the projection environment change as the second environment change. For example, if the projection angle change exceeds the projection angle threshold, the electronic device 100 may classify the projection environment change as the first environment change, and if the projection angle change is less than or equal to the projection angle threshold, the electronic device 100 may classify the projection environment change as the second environment change. For example, the projection distance threshold and the projection angle threshold may be values set by the user.

The electronic device 100 may determine a correction operation to be performed on the image based on the classification of the projection environment change. In an embodiment, if the projection environment change of the electronic device 100 is classified as the first environment change, the electronic device 100 may perform both focus correction and keystone correction. For example, in a case of the first environment change, the electronic device 100 may perform keystone correction after performing focus correction. For example, in the case of the first environment change, the electronic device 100 may perform focus correction after performing keystone correction. In an embodiment, if the projection environment change of the electronic device 100 is classified as the second environment change, the electronic device 100 may perform only one of focus correction and keystone correction. For example, in a case of the second environment change, the electronic device 100 may perform only focus correction on the image. For example, in the case of the second environment change, the electronic device 100 may only perform keystone correction on the image. As another example, in the case of the second environment change, the electronic device 100 may determine that correction (e.g., the focus correction and the keystone correction) of the image is not required and may determine to not perform the correction of the image.

Further, the electronic device 100 may determine whether the change in the projection environment is due to a physical action of the user based on the the detection data detected by the sensor. For example, the electronic device 100 may determine whether the electronic device 100 is moved in a vertical direction based on the detected data. For example, the electronic device 100 may determine whether the electronic device 100 is moved in the horizontal direction based on the detected data. For example, the electronic device 100 may determine whether the electronic device 100 is moved in a first direction based on the detected data. Here, the first direction may include a direction (e.g., a diagonal direction) other than the horizontal direction and the vertical direction. For example, the electronic device 100 may determine whether the electronic device 100 is tilted in the horizontal direction based on the detected data. For example, the electronic device 100 may determine whether the electronic device 100 is tilted in the vertical direction based on the detected data. For example, the electronic device 100 may determine whether the electronic device 100 is tilted in the first direction based on the detected data. Here, the first direction may include a direction (e.g., a diagonal direction) other than the horizontal direction and the vertical direction. According to an embodiment, in operation 320, the electronic device 100 may determine whether focus correction is required based on a change in the projection environment. For example, after detecting the projection environment change, the electronic device 100 may determine whether the focus correction on the image output on the projection surface is required based on the change in the projection distance and the projection angle. In particular, the electronic device 100 may first determine whether focus correction is required, and then determine whether keystone correction is required. For example, if the focus of the image output on the projection surface is changed based on the change in the projection distance and the projection angle, the electronic device 100 may determine that focus correction is required. For example, if the focus of the image output on the projection surface is not changed based on the change in the projection distance and the projection angle, the electronic device 100 may determine that focus correction is not required.

In operation 330, if focus correction is required, the electronic device 100 may perform the focus correction by determining movement information about the projection lens based on the projection distance and the projection angle. As illustrated in FIG. 5, the electronic device 100 may perform focus correction based on a distance Dₚ between the electronic device 100 and a projection surface PS and an angle Aₚ at which the electronic device 100 outputs the image IMG to the projection surface PS. For example, the electronic device 100 may perform focus correction by moving the projection lens based on the movement information.

According to an embodiment, in operation 340, the electronic device 100 may determine whether keystone correction is required, based on the projection environment change. For example, after determining whether focus correction is required, the electronic device 100 may determine whether the keystone correction is required for the image output on the projection surface based on the projection distance and the projection angle. For example, if the keystone of the image output on the projection surface is changed based on the projection distance and the projection angle, the electronic device 100 may determine that the keystone correction is required. For example, if the keystone of the image output on the projection surface is not changed according to the projection distance and the projection angle, the electronic device 100 may determine that the keystone correction is not required.

In operation 350, if the keystone correction is required, the electronic device 100 may perform the keystone correction by determining movement information about the projection lens based on the projection distance and the projection angle. As illustrated in FIG. 5, the electronic device 100 may perform keystone correction based on the distance Dₚ between the electronic device 100 and the projection surface PS and the angle Aₚ at which the electronic device 100 outputs the image IMG to the projection surface PS. For example, if distortion is detected (e.g., recognized) in the left-right direction of the screen, the electronic device 100 may perform horizontal keystone correction. For example, if distortion is detected (e.g., recognized) in the up-down direction of the screen, the electronic device 100 may perform vertical keystone correction.

Even after the keystone correction is performed, the electronic device 100 may perform additional focus correction based on a user input. For example, if the electronic device 100 determines that the focus correction is not required and performs only the keystone correction without the focus correction, the electronic device 100 may perform additional focus correction automatically or manually.

In an embodiment, the electronic device 100 may end the correction operation. For example, the electronic device 100 may end the correction operation after performing at least one of focus correction and keystone correction. Here, the electronic device 100 may perform an operation of identifying a correction result after performing at least one of focus correction and keystone correction. For example, the electronic device 100 may identify the correction result, and if it is determined that the correction is completed, the electronic device 100 may end the correction operation. For example, the electronic device 100 may identify the correction result, and if additional correction is required, the electronic device 100 may perform an additional correction operation on the image.

According to an embodiment, in operation 360, the electronic device 100 may output an image on the projection surface. For example, the projection assembly of the electronic device 100 may output an image on the projection surface in at least one method among a CRT method, a LCD method, a DLP method, and a laser method.

In an embodiment, if the electronic device 100 performs correction on the image output on the projection surface, the electronic device 100 may change a reproduction method of the image. For example, if the electronic device 100 corrects the image, the electronic device 100 may pause reproduction of the image output on the projection surface. For example, after performing the correction on the image, the electronic device 100 may rewind (e.g., go back) the reproduction of the image output on the projection surface to the time when the correction is started and reproduce the image again. For example, if the electronic device 100 performs correction on the image, the electronic device 100 may select whether to pause or rewind the image based on a user input.

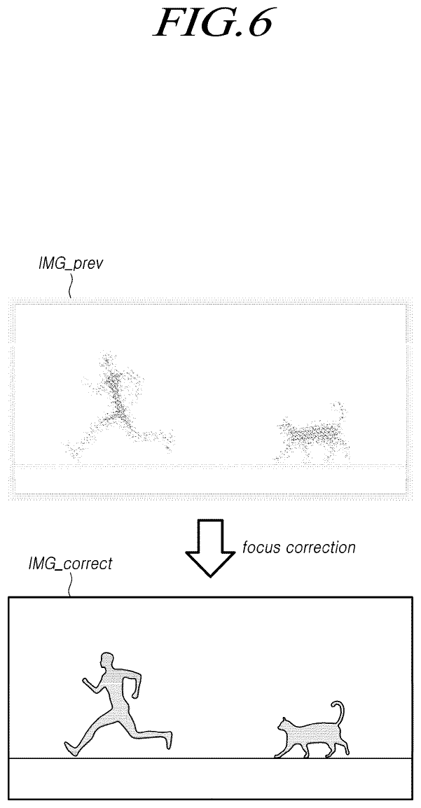

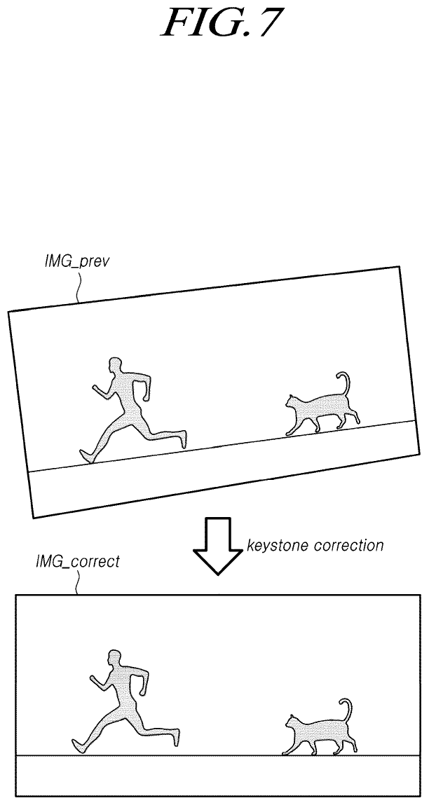

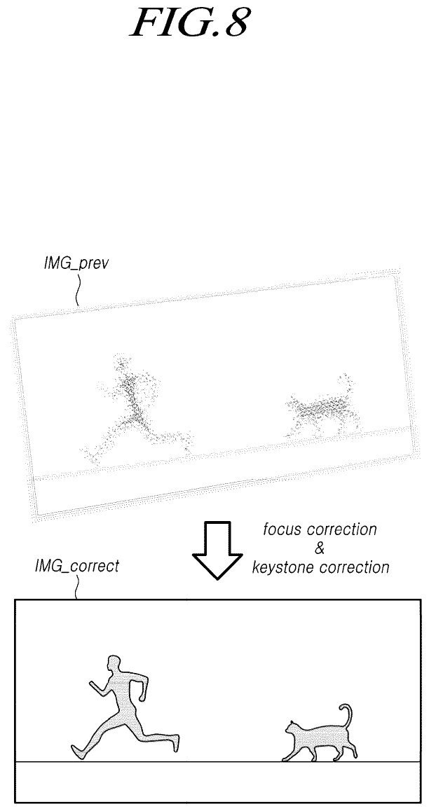

FIG. 6 illustrates focus correction of an electronic device according to an example embodiment. FIG. 7 illustrates keystone correction of an electronic device according to an example embodiment. FIG. 8 illustrates focus correction and keystone correction of an electronic device according to an example embodiment.

Referring to FIG. 6, the electronic device 100 may determine whether the focus correction of an image IMG_prev is required based on a change in the projection environment, and if the focus correction is required, the electronic device 100 may perform the focus correction on the image IMG_prev based on the projection distance and the projection angle. The electronic device 100 may determine whether keystone correction is required, and if keystone correction is not required, the electronic device 100 may not perform keystone correction. In other words, as illustrated in FIG. 6, the electronic device 100 may output a corrected image IMG_correct on the projection surface by performing only focus correction on the image IMG_prev.

The electronic device 100 may perform additional correction on the corrected image IMG_correct based on a user input. For example, the electronic device 100 may additionally perform manual keystone correction on the image IMG_correct obtained by performing the focus correction based on a user input. For example, the electronic device 100 may additionally perform manual focus correction and manual keystone correction on the image IMG_correct obtained by performing the focus correction based on a user input.

Referring to FIG. 7, the electronic device 100 may determine whether focus correction of the image IMG_prev is required based on a change in projection environment, and if focus correction is not required, the electronic device 100 may not perform focus correction. The electronic device 100 may determine whether keystone correction is required, and if keystone correction is required, the electronic device 100 may perform keystone on the image IMG_prev correction based on the projection distance and the projection angle. In other words, as illustrated in FIG. 7, the electronic device 100 may output the corrected image IMG_correct on the projection surface by performing only keystone correction on the image IMG_prev.

The electronic device 100 may perform additional correction on the corrected image IMG_correct based on a user input. For example, the electronic device 100 may additionally perform manual focus correction on the image IMG_correct obtained by performing the keystone correction based on a user input. For example, the electronic device 100 may additionally perform manual focus correction and manual keystone correction on the image IMG_correct obtained by performing the focus correction based on a user input.

Referring to FIG. 8, the electronic device 100 may determine whether the focus correction of an image IMG_prev is required based on a change in the projection environment, and if the focus correction is required, the electronic device 100 may perform the focus correction on the image IMG_prev based on the projection distance and the projection angle. The electronic device 100 may determine whether keystone correction is required, and if keystone correction is required, the electronic device 100 may perform keystone correction on the image IMG_prev based on the projection distance and the projection angle. In other words, as illustrated in FIG. 8, the electronic device 100 may output the corrected image IMG_correct on the projection surface by performing each of focus correction and keystone correction on the image IMG_prev. In particular, the electronic device 100 according to the disclosure may first determine whether focus correction is required for the image IMG_prev, and then determine whether keystone correction is required, thereby maximizing an effect of focus correction and keystone correction.

In an embodiment, the electronic device 100 may determine whether to perform the correction operation based on the information about the image output on the projection surface. In an embodiment, the electronic device 100 may determine whether to perform focus correction and keystone correction based on a playback time of the image output on the projection surface. For example, if the playback time of the image is larger than or equal to a reference playback time, the electronic device 100 may determine to perform focus correction and keystone correction on the image. For example, if the playback time of the image is less than the reference playback time, the electronic device 100 may determine not to perform focus correction and keystone correction on the image. In an embodiment, the user interface (e.g., 215 of FIG. 2) of the electronic device 200 may include at least one physical button for performing at least one of focus correction, keystone correction, and other correction. For example, the physical button may be implemented with multiple keys. Further, the user interface (e.g., 215 of FIG. 2) of the electronic device 200 may provide a correction guide for the image based on a change in the projection environment of the electronic device 100. For example, the user interface may provide a notification for correction required for the image.

In an embodiment, the electronic device 100 may receive a user input through an external remote control device. Here, the external remote control device may be a remote control device (e.g., a control device dedicated to the electronic device) corresponding to the electronic device 100 or a portable communication device (e.g., a smartphone or a wearable device). For example, the user may control the correction operation of the electronic device 100 through a smartphone or a wearable device.

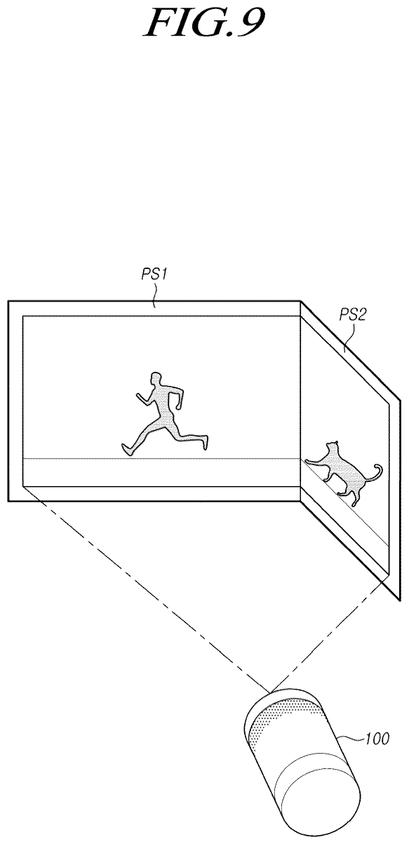

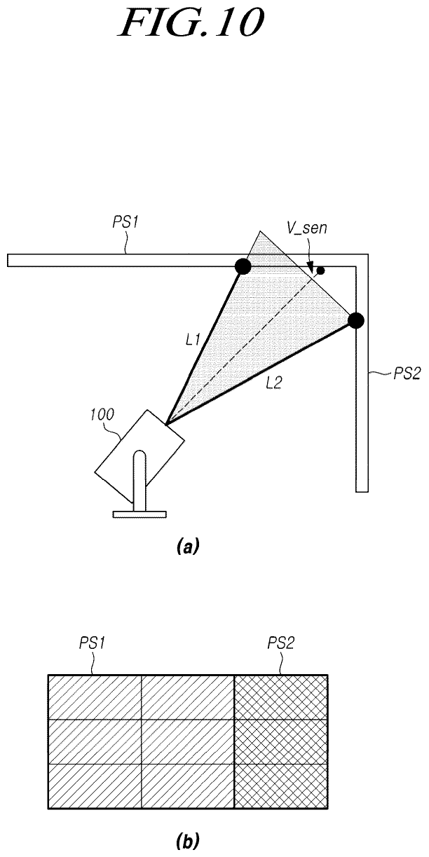

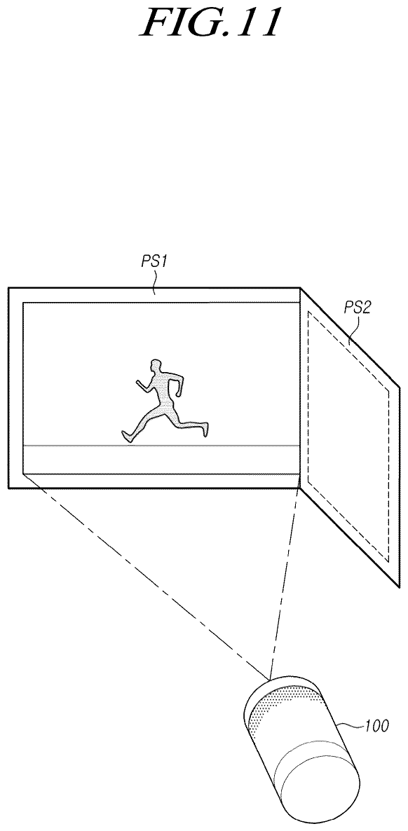

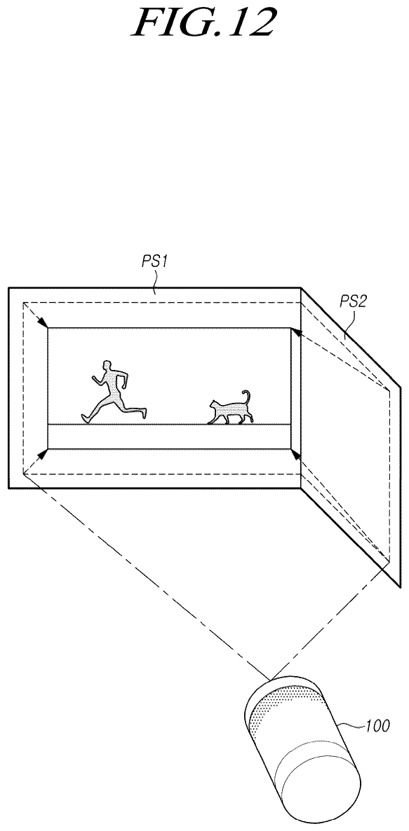

FIG. 9 illustrates a projection environment of an electronic device according to an example embodiment. FIG. 10 illustrates a projection surface detection operation of an electronic device according to an example embodiment. FIG. 11 illustrates an image output method of an electronic device according to an example embodiment. FIG. 12 illustrates an image output method of an electronic device according to an example embodiment.

The electronic device 100 may detect (e.g., determine) output size information related to the image and projection surface bend information. The electronic device may determine the image output to the projection surface based on the output size information about the image and the projection surface bend information. For example, the electronic device 100 may divide the projection surface into a plurality of areas PS1 and PS2 based on the projection surface bend information. Here, the plurality of areas may include at least one of a wall surface, a floor surface, or a ceiling surface recognized around the electronic device 200.

In an embodiment, as shown in (a) of FIG. 10, the electronic device 100 may obtain a distance L1 between a first end of the image output on the projection surface and the electronic device 100 and a distance L2 between a second end of the image output on the projection surface and the electronic device 100 using the distance sensor. Further, the electronic device 100 may obtain a pitch value V_sen for the center of the image output on the projection surface using the tilt sensor. The electronic device 100 may sense the output size information about the image and the projection surface bend information based on the detected data L1, L2, and V_sen. For example, as shown in (b) of FIG. 10, the electronic device 100 may determine output size information about the image and projection surface bend information in a plurality of unit blocks.

In an embodiment, the electronic device 100 may determine any one of the plurality of areas (e.g., PS1 and PS2) as an output area. The electronic device 100 may shift the projection lens to output the image to only one determined area. For example, if an image is displayed over a plurality of areas PS1 and PS2 of the projection surface, the image may be distorted. Accordingly, the electronic device 100 may output an image to only one area (e.g., PS1) of the projection surface. The electronic device 100 may determine the projection area occupying the largest portion of the projection surface as the output area based on the detected data L1, L2, and V_sen. For example, the electronic device 100 may determine a projection area (e.g., PS1) including the largest number of unit blocks on the projection surface as an output area. In this case, the electronic device 100 may shift (e.g. adjust or move) the projection lens or correct the size of the image to output the image to the determined output area.

In an embodiment, the electronic device 100 may shift (e.g., adjust or move) the projection lens based on the movement information. The movement information may include at least one of a moving direction and a moving distance. The electronic device 100 may control the projection assembly 211 to shift the projection lens based on the moving direction and the moving distance. For example, the electronic device 100 may shift (e.g., adjust or shift) the projection lens upward, downward, left, right, or the like with respect to a fixed axis of the projection lens. For example, the electronic device 100 may shift the projection lens by a calculated moving distance.

Referring to FIG. 11, the electronic device 100 may output only an image corresponding to the projection area having the largest size among the projection surfaces. The electronic device 100 may obtain the size of the projection areas (e.g., PS1 and PS2) included in the projection surface. The electronic device 100 may compare the respective sizes of the projection areas (e.g., PS1 and PS2) included in the projection surface. For example, the electronic device 100 may crop (e.g., cut or trim) and output only the image of the area PS1 having the largest size among the images output on the projection surface.

Referring to FIG. 12, the electronic device 100 may change and output the image based on the size of the projection area determined as the output area on the projection surface. The electronic device 100 may obtain the size of the projection area (e.g., PS1) determined as the output area. For example, the electronic device 100 may downsize (e.g., reduce) and output the entire image output on the projection surface according to the size of the projection area (e.g., PS1) determined as the output area.

As described above, the electronic device 100 according to an embodiment of the disclosure may provide a screen most suitable for the current projection surface to the user using the output size of the image and the projection surface information. In an embodiment, the electronic device 100 may correct the size of the image to correspond to the output area while moving the projection lens. Here, by moving the projection lens, the electronic device 100 may provide a screen suitable for a wider space, and by changing the size of the image, the electronic device 100 may generate an appropriate screen (e.g., display) by increasing or decreasing the size of the image. Accordingly, the electronic device 100 may generate an appropriate screen (e.g., display) and provide the screen to the user despite the distorted projection surface (or projection surface including a bend).

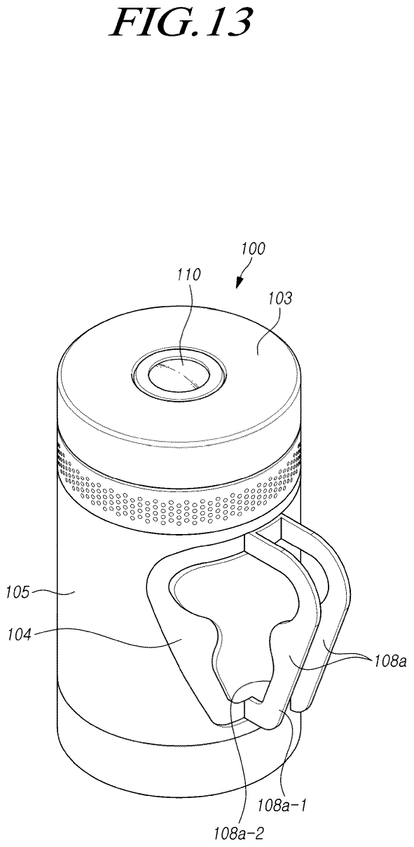

FIG. 13 illustrates an exterior of an electronic device 100 according to another example embodiment of the disclosure.

Referring to FIG. 13, the electronic device 100 may include a support (or a “handle”) 108a.

The support 108a according to one or more example embodiments may include a handle and/or a ring provided for the user to hold or move the electronic device 100, or the support 108a may be a stand supporting the main body 105 in a state in which the main body 105 is laid in a lateral direction.

As illustrated in FIG. 13, the support 108a may be connected by a hinge structure to be coupled to or separated from an outer circumferential side (e.g., surface) of the main body 105 and may be selectively separated from and fixed to the outer circumferential side (e.g., surface) of the main body 105. The number, shape, or arrangement structure of the supports 108a may be variously implemented without limitations. Although not illustrated in the drawings, the support 108a may be embedded in the main body 105 and may be taken out and used as needed, or the support 108a may be implemented as a separate accessory and may be detachable from the electronic device 100.

The support 108a may include a first support side (e.g., surface) 108a-1 and a second support side (e.g., surface) 108a-2. The first support side (e.g., surface) 108a-1 may be one side (e.g., surface) facing outward of the main body 105 in a state in which the support 108a is separated from the outer circumferential side (e.g., surface) of the main body 105, and the second support side (e.g., surface) 108a-2 may be one side (e.g., surface) facing inward of the main body 105 in a state in which the support 108a is separated from the outer circumferential side (e.g., surface) of the main body 105.

The first support side (e.g., surface) 108a-1 may be extended from the lower portion of the main body 105 to the upper portion of the main body 105 and may be disposed away from the main body 105, and the first support side (e.g., surface) 108a-1 may have a flat or uniformly curved shape. The first support side (e.g., surface) 108a-1 may support the main body 105 if the electronic device 100 is mounted such that the outer side (e.g., surface) of the main body 105 touches the bottom surface, e.g., if the projection lens 110 is disposed to face the front side (e.g., surface). In an embodiment including two or more supports 108a, the emission angle of the projection lens 110 and the head 103 may be adjusted by adjusting the distance between the two supports 108a or the angle at which the hinge is opened.

The second support side (e.g., surface) 108a-2 may be a side (e.g., surface) in contact with the user or an external mounting structure if the support 108a is supported by the user or the external mounting structure and may have a shape corresponding to the grip structure of the user's hand or the external mounting structure not to slip off when the electronic device 100 is supported or moved. The user may fix the head 103 with the projection lens 110 directed toward the front side (e.g., surface), hold the support 108a and move the electronic device 100, and use the electronic device 100 like a flashlight.

The support groove 104 may be provided in the main body 105 to receive the support 108a if the support 108a is not used and may be implemented as a groove structure corresponding to the shape of the support 108a in the outer circumferential side (e.g., surface) of the main body 105. If the support 108a is not used, the support 108a may be stored (e.g., positioned) on the outer circumferential side (e.g., surface) of the main body 105 through the support groove 104, and the outer circumferential side (e.g., surface) of the main body 105 may be maintained seamlessly.

Alternatively, the support 108a may have a structure in which the support 108a is stored (e.g., positioned) inside the main body 105 and, if the support 108a is required, the support 108a may be pulled out (e.g., extracted) of the main body 105. In this case, the support groove 104 may be a structure of being recessed into the main body 105 to receive the support 108a, and the second support side (e.g., surface) 108a-2 may be brought in tight contact with the outer circumferential side (e.g., surface) of the main body 105, or a separate door (not shown) for opening/closing the support groove 104 may be included.

Although not shown in the drawings, the electronic device 100 may include various types of accessories that help to use or store the electronic device 100. For example, the electronic device 100 may include a protective case (not shown) to protect and easily carry the electronic device 100 or may include a tripod (not shown) for supporting or fixing the main body 105 or a bracket (not shown) coupled to an outer side (e.g., surface) to fix the electronic device 100.

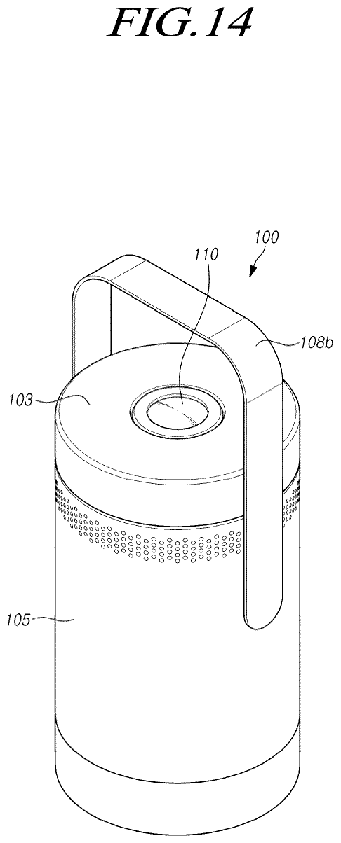

FIG. 14 illustrates an exterior of an electronic device 100 according to another example embodiment of the disclosure.

Referring to FIG. 14, the electronic device 100 may include a support (or a “handle”) 108b.

The support 108b according to one or more example embodiments may be a handle or a ring provided to grip, hold, or move the electronic device 100, or the support 108b may be a stand that supports the main body 105 to face at an arbitrary angle while the main body 105 is laid down in the lateral direction (e.g., laid down on a flat surface).

In an embodiment, as illustrated in FIG. 14, the support 108b may be connected to the main body 105 at a predetermined point (e.g., 2/3 to 3/4 of the height of the main body) of the main body 105. If the support 108 is rotated in the direction of the main body, the support 108 may support the main body 105 to face at an arbitrary angle while the main body 105 is laid down in the lateral direction.

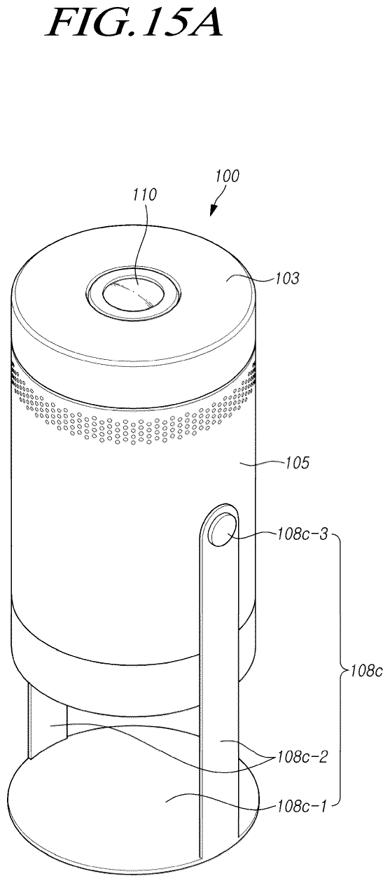

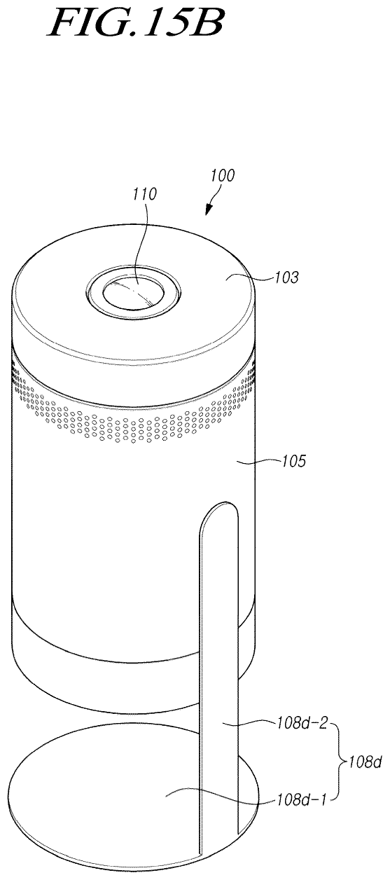

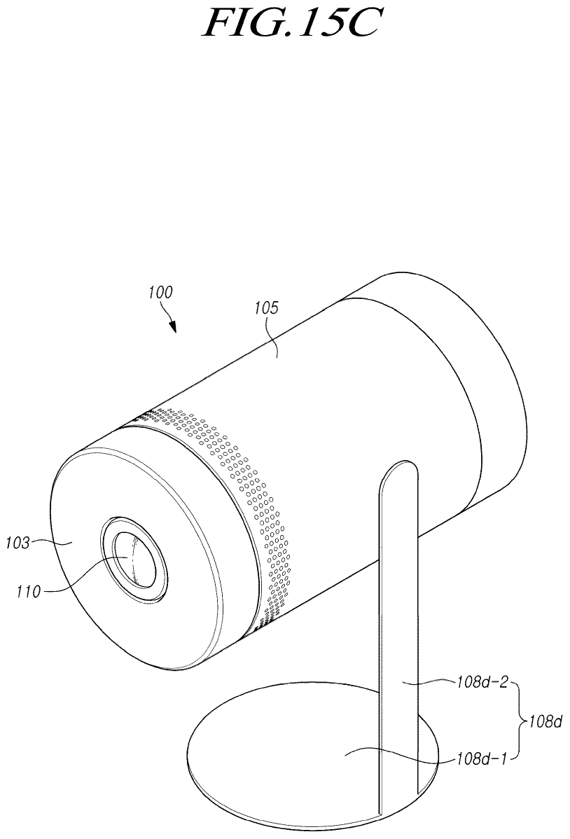

FIGS. 15A to 15C illustrate an exterior of an electronic device 100 according to other examples embodiment of the disclosure.

Referring to FIG. 15A, the electronic device 100 may include a support (or a “base”) 108c. The support 108c according to one or more example embodiments may include a base plate 108c-1 provided to support the electronic device 100 on the ground and two supporting members 108c-2 connecting the base plate 108-c and the main body 105.

According to an embodiment of the disclosure, because the two supporting members 108c-2 have the same height, the respective cross-sections of the two supporting members 108c-2 may be coupled to or separated from each other by a groove provided in one outer circumferential side (e.g., surface) of the main body 105 and a hinge member 108c-3.

The two supporting members may be hinged to the main body 105 at a preset point (e.g., 1/3 to 1/2 of the height of the main body) of the main body 105.

When the two supporting members and the main body are coupled by the hinge member 108c-3, the main body 105 may be rotated about a virtual horizontal axis formed by the two hinge members 108c-3, such that the emission angle of the projection lens 110 may be adjusted.

FIG. 15A illustrates an embodiment in which two supporting members 108c-2 are connected to the main body 105, but the disclosure is not limited thereto, and one supporting member and the main body 105 may be connected by one hinge member.

Referring to FIGS. 15B and 15C, the support 108d according to one or more example embodiments may include a base plate 108d-1 provided to support the electronic device 100 on the ground and one supporting member 108d-2 connecting the base plate 108-c and the main body 105.

The cross section of the one supporting member 108d-2 may be coupled to or separated from a groove provided in one outer circumferential side (e.g., surface) of the main body 105 by a hinge member (not shown).

If the one supporting member 108d-2 and the main body 105 are coupled by one hinge member (not shown), the main body 105 may be rotated about a virtual horizontal axis formed by the one hinge member (not shown) as shown in FIG. 15C.

The support illustrated in FIGS. 13, 14, 15A, 15B, and 15C is merely an embodiment, and the electronic device 100 may include a support in various positions or shapes.

The display device according to one or more example embodiments of the disclosure may be one of various types of electronic devices. The display devices may include, for example, a portable communication device (e.g., a smartphone), a computer device, a portable multimedia device, a portable medical device, a camera, a wearable device, or a home appliance. The display devices according to an embodiment of the disclosure are not limited to the above-described devices.

It should be appreciated that one or more example embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in one or more example embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 200 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., ROM, RAM, floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a projection assembly including a projection lens, the projection assembly configured to output an image to a projection surface;
a memory configured to store at least one instruction;
at least one sensor; and
at least one processor configured to execute the at least one instruction, which causes the at least one processor to:
detect a change in a projection environment;
determine whether a focus correction is required for the image output to the projection surface, based on the change in the projection environment;
after determining whether the focus correction is required, determine whether a keystone correction is required for the image, based on the change in the projection environment; and
control the projection assembly to output a corrected image to the projection surface.

2. The electronic device of claim 1, wherein the at least one sensor is configured to determine at least one of a projection distance and a projection angle, and
wherein the at least one instruction causes the at least one processor to detect the change in the projection environment based on a change in at least one of the projection distance or the projection angle.

3. The electronic device of claim 1, wherein the at least one sensor is configured to determine at least one of a projection distance and a projection angle, and
wherein the at least one instruction causes the at least one processor to determine, based on the projection distance and the projection angle, whether the focus correction is required for the image output to the projection surface.

4. The electronic device of claim 1, wherein the at least one sensor is configured to determine at least one of a projection distance and a projection angle, and
wherein the at least one instruction causes the at least one processor to, after determining whether the focus correction is required, determine, based on the projection distance and the projection angle, whether the keystone correction is required for the image output to the projection surface.

5. The electronic device of claim 1, wherein the at least one sensor is configured to determine at least one of a projection distance and a projection angle, and
wherein the at least one instruction causes the at least one processor to perform the at least one of the focus correction or the keystone correction by determining movement information about the projection lens based on the projection distance and the projection angle.

6. The electronic device of claim 5, wherein the movement information about the projection lens includes at least one of a moving direction of the projection lens or a moving distance of the projection lens, and
wherein the projection assembly is configured to control a movement of the projection lens based on the movement information.

7. The electronic device of claim 1, wherein the at least one sensor is configured to determine image output size information and projection surface bend information, and
wherein the at least one instruction causes the at least one processor to correct a range and a size of the image output to the projection surface based on the image output size information and the projection surface bend information.

8. The electronic device of claim 7, wherein the at least one instruction causes the at least one processor to determine one of at least one projection area of the projection surface as an output area to which the image is to be output, based on the image output size information and the projection surface bend information.

9. The electronic device of claim 8, wherein the at least one instruction causes the at least one processor to crop the image corresponding to a projection area having a largest size among the at least one projection area and output the cropped image to the output area.

10. The electronic device of claim 8, wherein the at least one instruction causes the at least one processor to downsize the image output to the projection surface to a size of the output area and output the downsized image to the output area.

11. A method of driving an electronic device, the method comprising:
detecting a change in a projection environment;
determining whether a focus correction is required based on the change in the projection environment;
after determining whether the focus correction is required, determining whether a keystone correction is required;
correcting the image; and
outputting a corrected image to a projection surface.

12. The method of claim 11, wherein the detecting the change in the projection environment includes:
determining at least one of a projection distance and a projection angle; and
detecting the change in the projection environment based on a change in at least one of the projection distance or the projection angle.

13. The method of claim 11, wherein the detecting the change in the projection environment includes determining at least one of a projection distance and a projection angle; and
wherein the determining whether the focus correction is required includes determining, based on the projection distance and the projection angle, whether the focus correction is required for the image output to the projection surface.

14. The method of claim 11, wherein the detecting the change in the projection environment includes determining at least one of a projection distance and a projection angle, and
wherein the determining whether the keystone correction is required includes: after determining whether the focus correction is required, determining, based on the projection distance and the projection angle, whether the keystone correction is required for the image output to the projection surface.

15. The method of claim 11, wherein the detecting the change in the projection environment includes determining at least one of a projection distance and a projection angle, and
wherein the correcting the image includes performing at least one of the focus correction and the keystone correction by determining movement information about a projection lens based on the projection distance and the projection angle.

16. The method of claim 15, wherein the movement information about the projection lens includes at least one of a moving direction of the projection lens or a moving distance of the projection lens, and
wherein the correcting the image includes controlling a movement of the projection lens based on the movement information.

17. The method of claim 11, wherein the detecting the change in the projection environment includes determining image output size information and projection surface bend information, and
wherein the correcting the image includes correcting a range and a size of the image output to the projection surface based on the image output size information and the projection surface bend information.

18. The method of claim 17, wherein the correcting the image includes determining one of at least one projection area of the projection surface as an output area to which the image is to be output, based on the image output size information and the projection surface bend information.

19. The method of claim 18, wherein the correcting the image includes cropping the image corresponding to a projection area having a largest size among the at least one projection area, and
wherein the outputting the corrected image to the projection surface includes outputting the cropped image to the output area.

20. The method of claim 18, wherein the correcting the image includes downsizing the image output to the projection surface to a size of the output area, and
wherein the outputting the corrected image to the projection surface includes outputting the downsized image to the output area.
